(19) United States
(12) Patent Application Publication
(10) Pub. No.: US 2010/0282923 A1
(43) Pub. Date: Nov. 11, 2010

(54) HINGE ASSEMBLY AND SUPPORT USING THE SAME

(75) Inventors: JIN-XIN WANG, Shenzhen City (CN); HAN-ZHENG ZHANG, Shenzhen City (CN); JIAN LI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD ., Shenzhen City (CN); HON HAI PRECISION INDUSTRYCO., LTD., Tu-Cheng (CN)

(21) Appl. No.: 12/497,784

(22) Filed: Jul. 6, 2009

(30) Foreign Application Priority Data
May 11, 2009 (CN) 200910302215.8

(51) Int. Cl. F16M 11/38; E05D 11/08

(52) U.S. Cl. 248/158; 16/337

(57) ABSTRACT

A hinge assembly includes a shaft, a resisting member, and an engaging member. The resisting member is sleeved on the shaft. The resisting member comprises a sleeve portion and a warped portion. The warped portion comprises a root connected to an edge of the sleeve portion and a free end away from the sleeve portion. The warped portion gradually deflects towards a side of the sleeve portion from the root to the free end. The engaging member is sleeved on the shaft to resist the warped portion of the resisting member. The engaging member and the resisting member are rotatable relative to each other.

### BACKGROUND

1. Technical Field

The present disclosure generally relates to hinge assemblies and supports and, particularly, to a hinge assembly and a support applying the hinge assembly for electronic devices.

2. Description of Related Art

Electronic devices or components thereof, such as notebooks, liquid crystal displays, reading lamps, webcams, electronic magnifiers, or others, are often adjustable for access and viewing angle to satisfy different user requirements.

A typical hinge assembly utilized in such adjustment includes two engaged washers. One of the washers forms a protrusion and the other a depression. With the protrusion engaging or disengaging the depression, force applied on the electronic device to rotate the movable part is required, requiring undue effort to make the adjustment.

Therefore, a hinge assembly and a support using the hinge assembly are desired to overcome the described limitations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an assembled, perspective view of an embodiment of a support, the support including a base, a first connecting member, a first arm, a second arm, a first hinge assembly, a second connecting member, a second hinge assembly, and a third hinge assembly.

FIG. 2 is an exploded, perspective view of an embodiment of the first hinge assembly, applicable in a support, for example, that of FIG. 1.

FIG. 3 is similar to FIG. 2, but viewed from another aspect.

FIG. 4 is a cross-section of the first hinge assembly of FIG. 2.

FIG. 5 is a perspective view of a washer and an elastic piece of the first hinge assembly of FIG. 2.

FIG. 6 is an exploded, perspective view of the second hinge assembly of FIG 1.

FIG. 7 is similar to FIG. 6, but viewed from another aspect.

### DETAILED DESCRIPTIONS

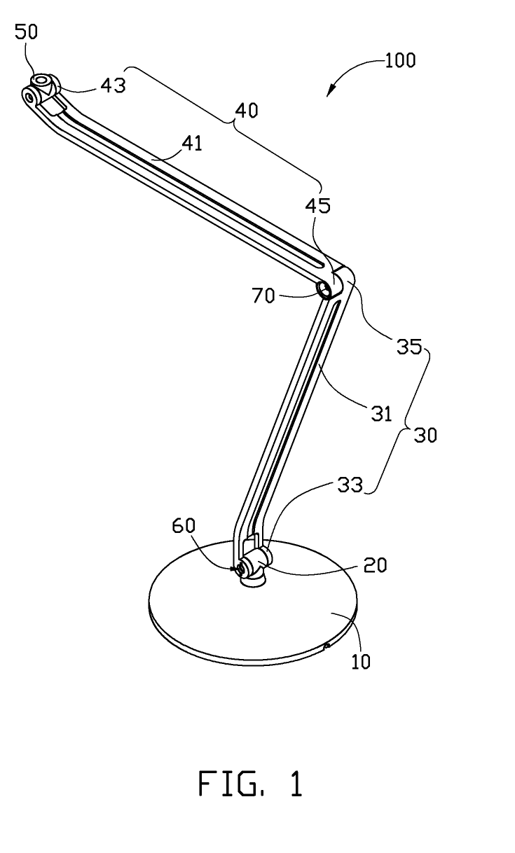

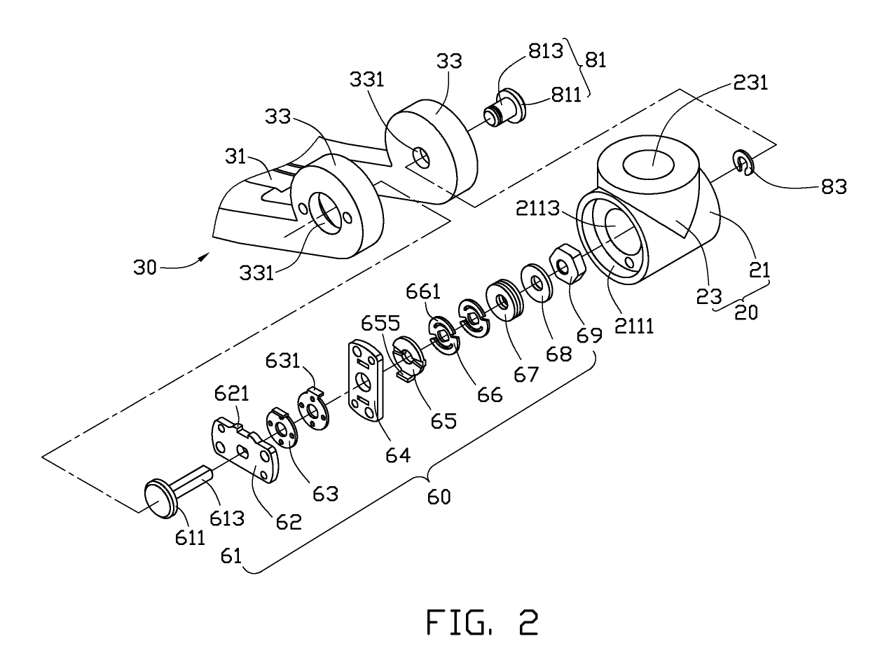

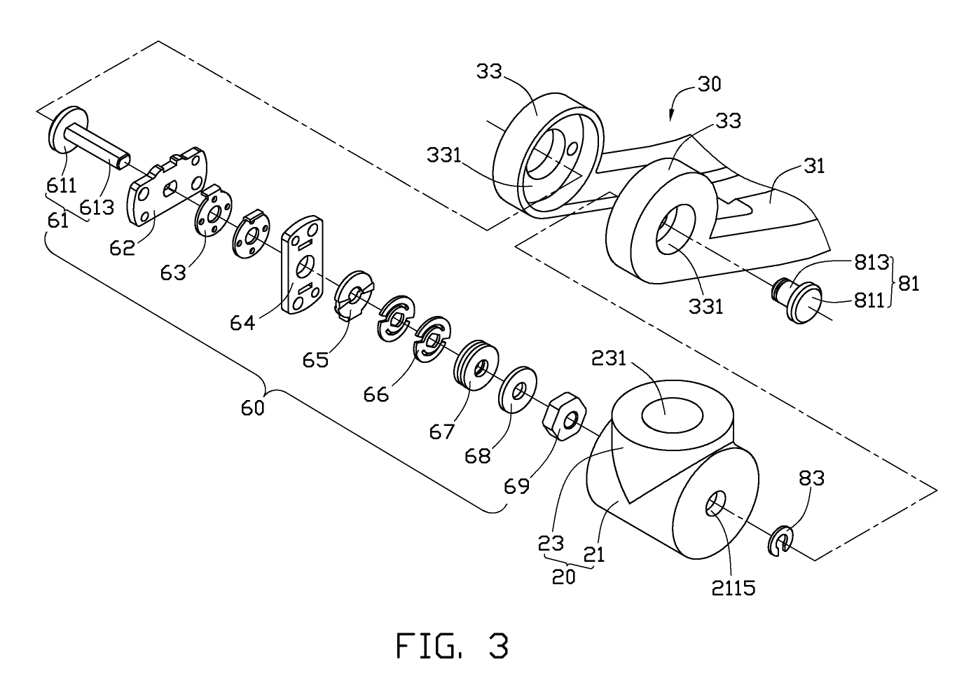

Referring to FIGS. 1-3, an embodiment of a support 100 includes a base 10, a first connecting member 20, a first arm 30, a second arm 40, a second connecting member 50, a first hinge assembly 60, a second hinge assembly 70, and a third hinge assembly (not shown). The first hinge assembly 60 pivotally connects the first connecting member 20 with the first arm 30, the second hinge assembly 70 pivotally connects the first arm 30 and the second arm 40, and the third hinge assembly pivotally connects the second arm 40 and the second connecting member 50. The base 10 is connected to the first connecting member 20 and supports the remaining components. The first and second connecting members 20, 50 have the same structure, and the first, second, and third hinge assemblies have similar structure.

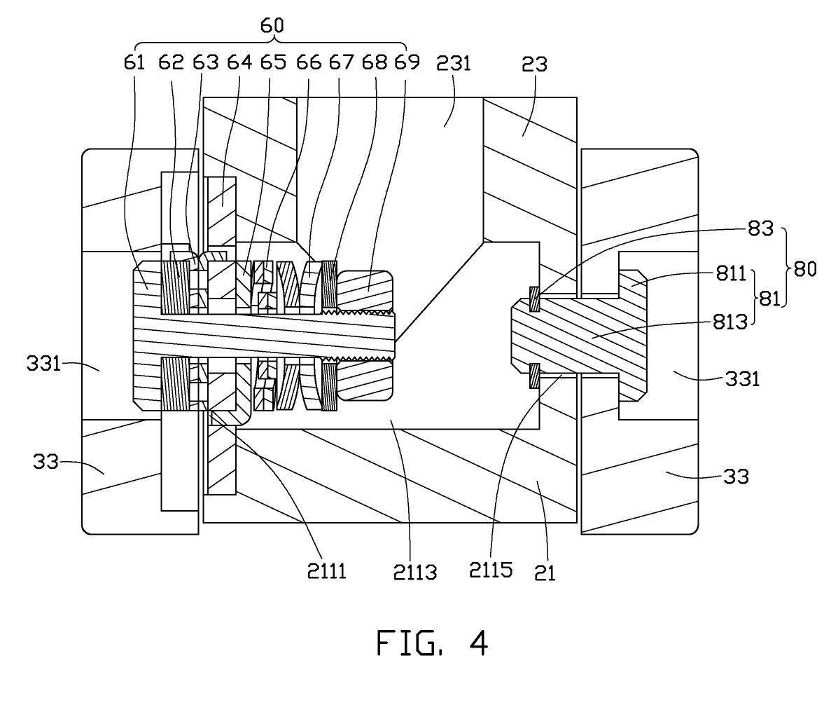

The first connecting member 20 includes a pivot portion 21 and a connecting portion 23 substantially perpendicular to the pivot portion 21. The pivot portion 21 and the connecting portion 23 are substantially cylindrical. Referring also to FIG. 4, the pivot portion 21 defines a first hole 2111, a second hole 2113, and a third hole 2115 arranged in that order. The second hole 2113 has a diameter larger than the third hole 2115 and smaller than the first hole 2111. The connecting portion 23 defines a shaft hole 231 communicating with the second hole 2113.

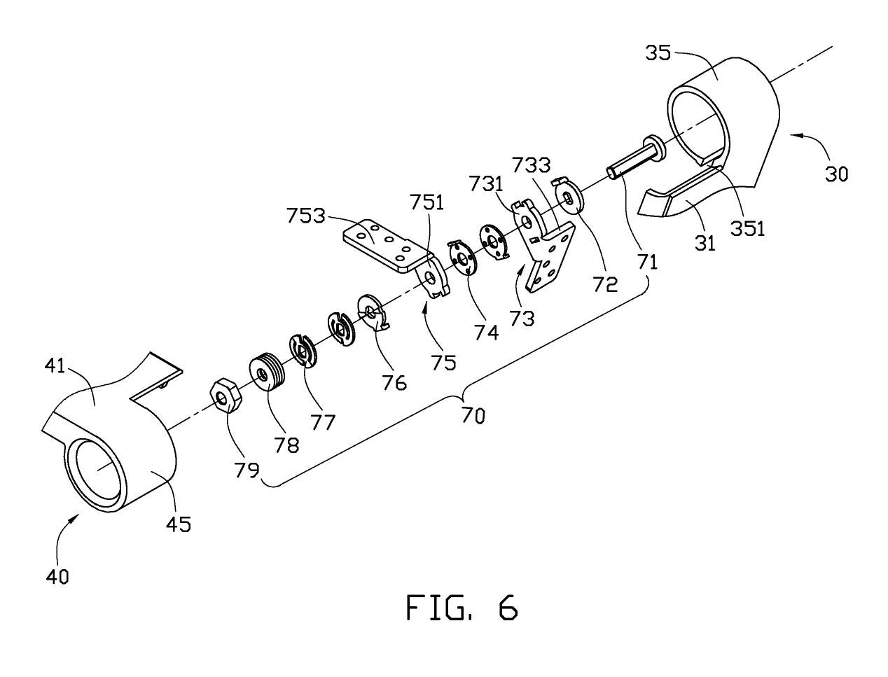

The first and second arms 30, 40 have the same structure. The first arm 30 includes a main portion 31, two first pivot ends 33 extending from an end of the main portion 31, and a first tube 35 extending from an opposite end of the main portion 31. Referring to FIG. 6, the second arm 40 includes a main portion 41, two second pivot ends 43 extending from an end of the main portion 41, and a second tube 45 extending from an opposite end of the main portion 41. Each of the first pivot ends 33 defines a pivot hole 331.

The first hinge assembly 60 includes a shaft 61, a first fixing member 62, two friction washers 63, a second fixing member 64, an engaging washer 65, two resisting washers 66, an elastic unit 67, a flat washer 68, and a fastening member 69. The first hinge assembly 60 may include only one resisting washer 66.

The shaft 61 includes a cap 611 and a shaft portion 613. A cross-section of the shaft portion 613 is non-circular. The first fixing member 62 may be a rectangular plate forming two holding protrusions 621 at an edge. The first fixing member 62 is received in the pivot hole 331 of one of the first pivot ends 33 and fixed to the first pivot end 33 via a plurality of fasteners, such as bolts (not shown). The friction washer 63 forms a latching protrusion 631 at an edge. The second fixing member 64 may be a rectangular plate. The second fixing member 64 is received in the first hole 2111 and fixed to the first connecting member 20 via a plurality of fasteners (not shown). The latching protrusion 631 of one of the friction washers 63 is held between the holding protrusions 621 of the first fixing member 62, and the latching protrusion 631 of the other friction washer 63 is engaged in the second fixing member 64.

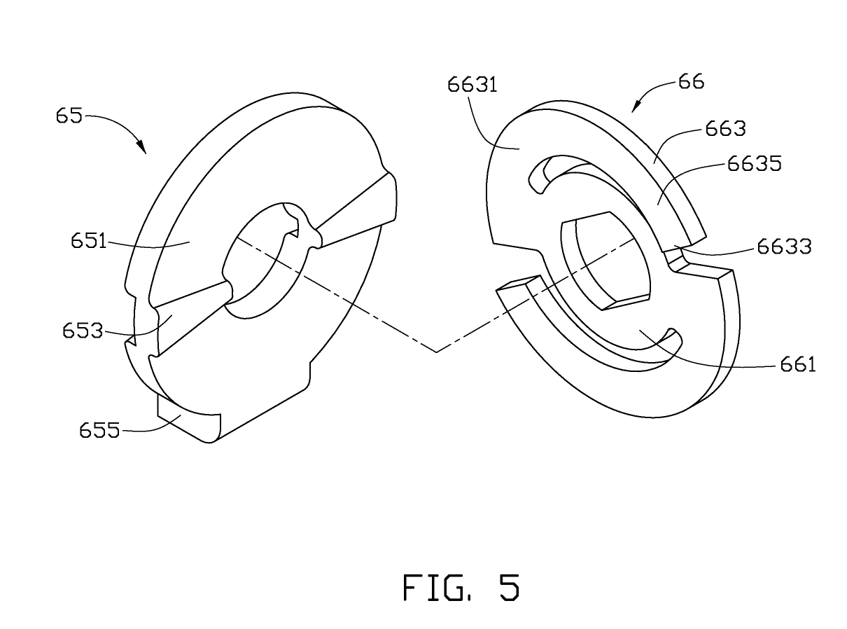

Referring to FIG. 5, the engaging washer 65 is substantially annular. The engaging washer 65 includes a resisting surface 651 and forms two symmetrical projections 653 on the resisting surface 651. The engaging washer 65 further forms a tab 655 at an edge to engage the second fixing member 64.

The resisting washers 66 have the same structure. Each resisting washer 66 includes an annular sleeve portion 661 and two warped portions 663. Each warped portion 663 includes a root 6631 connected to an edge of the sleeve portion 661 and a free end 6633 away from the sleeve portion 661. The warped portion 663 extends along a line substantially parallel to a periphery of the sleeve portion 661. The warped portion 663 gradually deflects towards a side of the sleeve portion 661 from the root 6631 to the free end 6633, thus defining an inclined surface 6635. A distance “L” and an angle “A” satisfy a formula of L=sin (A), wherein “L” is the distance between the warped portion 663 and the sleeve portion 661, and “A” is an angle defined by a first imaginary line connecting a center of the sleeve portion 661 and the root 6631 and a second imaginary line connecting the center of the sleeve portion 661 and one of any point on the warped portion 663. The distance “L” gradually increases along an axis parallel to the axis of the sleeve portion 661 from the root 6631 to the free end 6633. A connecting portion between the sleeve portion 661 and the warped portion 663 is smooth.

The fastening member 69 is a nut as shown in the illustrated embodiment. The engaging washer 65 may form one single projection 653 and the resisting washer 66 may include one single warped portion 663. The first fixing member 62 and the resisting washers 66 have non-circular center holes corresponding to the cross-section of the shaft portion 613 of the shaft 61. The remaining components of the first hinge assembly 60 other than the first fixing member 62 and the resisting washers 66 have circular holes in a center portion.

The first hinge assembly 60 is assembled first when connecting the first arm 30 to the first connecting member 20. The first connecting member 20, the friction washers 63, the second fixing member 64, the engaging washer 65, the resisting washers 66, the elastic unit 67, and the flat washer 68, are sleeved on the shaft portion 613 of the shaft 61 in that order, and the fastening member 69 engages an end of the shaft portion 613. The first and second fixing members 62, 64 are staggered at an angle so as to not cover the threaded holes thereon. As such, the first hinge assembly 60 is assembled. The first hinge assembly 60 extends in one of the first pivot ends 33 with the engaging washer 65, the resisting washers 66, the elastic unit 67, the flat washer 68, and the fastening member 69 received in the second hole 2113, and the second fixing member 64 and one friction washer 63 received in the first hole 2111. The second fixing member 64 is fixed to the first connecting member 20.

The first hinge assembly 60, together with the first connecting member 20, is positioned between the first pivot ends 33 of the first arm 30. The cap 611 of the shaft 61, the first fixing member 62, and the other friction washer 63 are received in the pivot hole 331 of the first arm 30. The first fixing member 62 resists a step surface (not labeled) of the first pivot end 33 and the second fixing member 64 resists a step surface (not labeled) between the first hole 2111 and the second hole 2113 of the first connecting member 20. The first fixing member 62 is fixed to the first pivot end 33. The shaft 61, the first fixing member 62, the resisting washers 66, and the first arm 30 are rotatable relative to the second fixing member 64, the engaging washer 65, and the first connecting member 20.

To allow the first arm 30 to rotate relative to the first connecting member 20 more steadily, the first hinge assembly 60 further includes a rotation unit 80 having a shaft 81 and a clip 83. The shaft 81 includes an end portion 811 and an extending portion 813. The end portion 811 is received in the pivot hole 331 of the other first pivot end 33 and resists a step surface of the first pivot end 33, and the extending portion 813 extends through the pivot hole 331 and into the second hole 2113 of the first connecting member 20. The clip 83 engages an end of the extending portion 813.

When the first arm 30 rotates relative to the first connecting member 20, the engaging washer 65 resists the warped portions 663 of one of the resisting washers 66. When rotating the first arm 30, a resisting force between the engaging washer 65 and the resisting washer 66 gradually changes, as does a friction force between the components of the first hinge assembly 60 and the first pivot ends 33 of the first arm 30. A moment of gravity of the movable part of the electronic device changes due to the rotation of the movable part to a different angle. A moment of the friction force changes accordingly to balance the changing moment of gravity of the movable part of the electronic device, so that the first arm 30 is capable of remaining stable in any position.

When the first arm 30 is in a first position relative to the first connecting member 20, that is, when the first arm 30 is substantially perpendicular to the base 10, a friction force between the components of the first hinge assembly 60 is at its minimum, and the projections 653 of the engaging washer 65 resist the roots 6631 of the warped portions 663 of the resisting washer 66. When the first arm 30 rotates, the projections 653 slide along the warped portions 663 and the friction force between the components of the first hinge assembly 60 gradually increases. Therefore, the moment of the increased friction force balances the increased moment of gravity of the first arm 30 and members supported by the first arm 30. Therefore, a force required to rotate the first arm 30 remains approximately unchanged. Adjustment of the first arm 30 is thus easier. In addition, the engaging washer 65 and the resisting washers 66 are manufactured by punching, considerably simplifying production and reducing costs thereof.

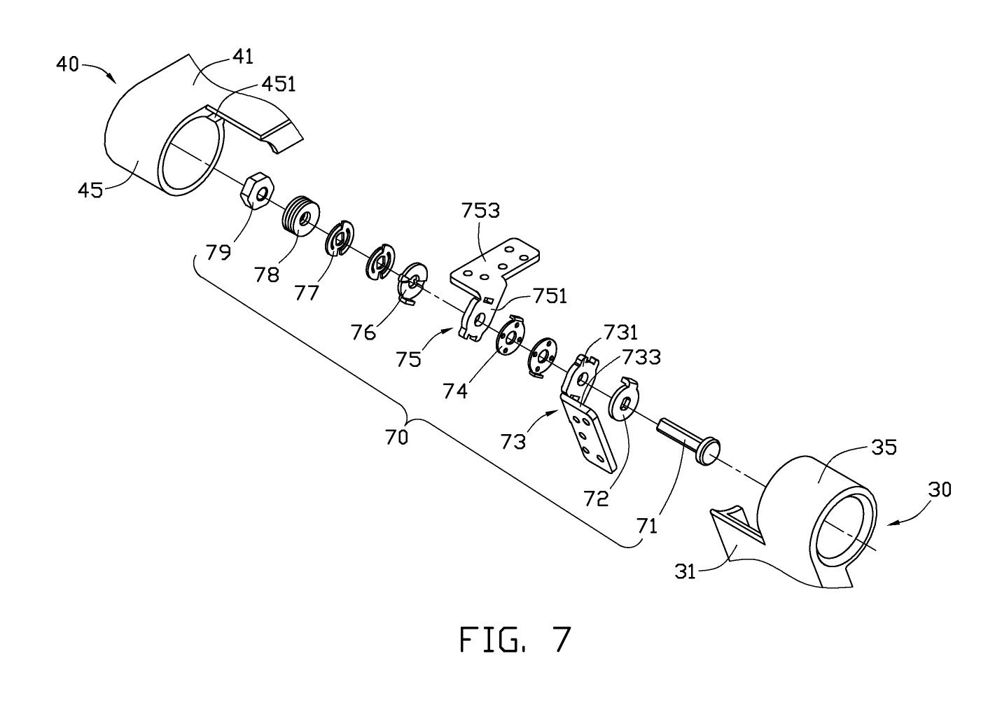

Referring to FIG. 1, FIG. 6 and FIG. 7, the second hinge assembly 70 has a structure similar to the first hinge assembly 60.

The second hinge assembly 70 includes a shaft 71, a latching washer 72, a first fixing member 73, two friction washers 74, a second fixing member 75, an engaging washer 76, two resisting washers 77, an elastic unit 78, and a fastening member 79. The first tube 35 defines a slot 351, and the second tube 45 defines a groove 451. The first fixing member 73 includes a pivot portion 731 and a latching portion 733 substantially perpendicular to the pivot portion 731. The latching portion 733 is latched in the slot 351 to fix the first fixing member 73 to the first arm 30. The fixing member 75 includes a pivot portion 751 and a latching portion 753 substantially perpendicular to the pivot portion 751. The latching portion 753 is latched in the groove 451 to fix the first fixing member 75 to the second arm 40.

Alternatively, the second hinge assembly 70 may have the same structure as the first hinge assembly 60. Accordingly, the first tube 35 and the second tube 45 have similar structures to the first pivot ends 33 and the pivot portion 21. Similarly, the second arm 40 is capable of remaining in any position relative to the first arm 30. The warped portions 663 of the resisting washers 66 and the warped portion of the resisting washers 77 may or may not be elastic. In the illustrated embodiment, the warped portions are elastic.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A hinge assembly, comprising:
a shaft;
a resisting member sleeved on the shaft, the resisting member comprising a sleeve portion and a warped portion, the warped portion comprising a root connected to an edge of the sleeve portion and a free end away from the sleeve portion, the warped portion gradually deflecting towards a side of the sleeve portion from the root to the free end; and
an engaging member sleeved on the shaft to resist the warped portion of the resisting member, wherein the engaging member and the resisting member are rotatable relative to each other.

2. The hinge assembly of claim 1, wherein the warped portion defines an inclined surface; a projection is formed on the engaging member to resist the inclined surface.

3. The hinge assembly of claim 1, wherein the warped portion of the resisting member extends substantially parallel to a periphery of the sleeve portion.

4. The hinge assembly of claim 1, wherein the engaging member is an engaging washer; the resisting member is a resisting washer.

5. The hinge assembly of claim 1, wherein the warped portion of the resisting member is elastic.

6. The hinge assembly of claim 1, wherein the hinge assembly satisfies a formula of L=sin (A), wherein “L” is a distance between the warped portion and the sleeve portion, and “A” is an angle defined by a first imaginary line connecting a center of the sleeve portion and the root and an imaginary line connecting the center of the sleeve portion and a point on the warped portion.

7. The hinge assembly of claim 1, further comprising a first fixing member and a second fixing member; the engaging member and one of the first and second fixing members are rotatable relative to the shaft, and the resisting member and the other one of the first and second fixing members are non-rotatable relative to the shaft.

8. The hinge assembly of claim 7, further comprising two friction washers, an elastic unit, a flat washer, and a fastening member sleeved on the shaft.

9. A support, comprising:
a base;
a first connecting member supported by the base;
a first arm; and
a hinge assembly connecting the first arm to the first connecting member, the hinge assembly comprising:
a shaft running through the first connecting member and the first arm;
a resisting member sleeved on the shaft and fixed relative to the first arm, the resisting member comprising a sleeve portion and a warped portion, the warped portion comprising a root connected to an edge of the sleeve portion and a free end away from the sleeve portion, the warped portion gradually deflecting towards a side of the sleeve portion from the root to the free end; and
an engaging member sleeved on the shaft to resist the warped portion of the resisting member, wherein the engaging member and the resisting member are rotatable relative to each other.

10. The support of claim 9, wherein the warped portion defines an inclined surface; the engaging member forms a projection to resist the inclined surface.

11. The support of claim 9, wherein the warped portion of the resisting member extends substantially parallel to a periphery of the sleeve portion.

12. The support of claim 9, wherein the engaging member is an engaging washer; the resisting member is a resisting washer.

13. The support of claim 9, wherein the warped portion of the resisting member is elastic.

14. The support of claim 9, wherein the hinge assembly satisfies a formula of L=sin (A), wherein “L” is a distance between the warped portion and the sleeve portion, and “A” is an angle defined by a first imaginary line connecting a center of the sleeve portion and the root and an imaginary line connecting the center of the sleeve portion and a point on the warped portion.

15. The support of claim 9, wherein the hinge assembly further comprises a first fixing member and a second fixing member; the engaging member and one of the first and second fixing members are rotatable relative to the shaft, and the resisting member and the other one of the first and second fixing members are non-rotatable relative to the shaft.

16. The support of claim 15, wherein the hinge assembly further comprises two friction washers, an elastic unit, a flat washer, and a fastening member sleeved on the shaft.

17. The support of claim 9, further comprising a second arm, a second connecting member, and a second hinge assembly connecting the second arm and the first arm.

18. The support of claim 17, wherein the second hinge assembly comprises a shaft, an engaging member, and a resisting member sleeved on the shaft and fixed relative to the first arm, the resisting member comprises a sleeve portion and a warped portion, the warped portion comprises a root connected to an edge of the sleeve portion and a free end away from the sleeve portion, the warped portion gradually deflects towards a side of the sleeve portion from the root to the free end; the engaging member is sleeved on the shaft to resist the warped portion of the resisting member; the engaging member and the resisting member are rotatable relative to each other.
